(19) United States
(12) Patent Application Publication
(10) Pub. No.: US 2025/0013161 A1
(43) Pub. Date: Jan. 9, 2025

(54) RESIN PARTICLE, TONER, DEVELOPING AGENT, AND TONER ACCOMMODATING UNIT

(71) Applicants: akio Takei, Shizuoka (JP); Junichi Watanabe, Shizuoka (JP); Yuka Mizoguchi, Shizuoka (JP); Suzuka Karato, Shizuoka (JP); Shinya Nakayama, Shizuoka (JP)

(72) Inventors: akio Takei, Shizuoka (JP); Junichi Watanabe, Shizuoka (JP); Yuka Mizoguchi, Shizuoka (JP); Suzuka Karato, Shizuoka (JP); Shinya Nakayama, Shizuoka (JP)

(73) Assignee: Ricoh Company, Ltd., Tokyo (JP)

(21) Appl. No.: 18/754,720

(22) Filed: Jun. 26, 2024

(30) Foreign Application Priority Data
Jul. 3, 2023 (JP) 2023-109090

(51) Int. Cl. G03G 9/087; G03G 9/097

(52) U.S. Cl. CPC G03G 9/08755; G03G 9/09733; G03G 2215/0607; G03G 2215/066

(57) ABSTRACT

A resin particle contains a binder resin containing a polyester resin containing polyethylene terephthalate and a diol component of propylene glycol and a release agent containing an ester wax.

### CROSS-REFERENCE TO RELATED APPLICATIONS

This patent application is based on and claims priority pursuant to 35 U.S.C. § 119 to Japanese Patent Application No. 2023-109090, filed on Jul. 3, 2023, in the Japan Patent Office, the entire disclosure of which is hereby incorporated by reference herein.

### BACKGROUND

### Technical Field

The present disclosure is related to a resin particle, a toner, a developing agent, and a toner accommodating unit.

### Description of the Related Art

In recent years, there has been a demand for reduced environmental impact in toner production. To address this issue, measures such as reducing energy consumption during manufacturing and adopting plant-based resins for the binder resin are being discussed.

Today's toner is known to contain a release agent for effective fixation. Moreover, a dispersant is added to the resin particle to disperse the release agent in the toner. However, these dispersants are derived from petroleum sources, leading to increased environmental burden. It is thus desirable to reduce the amount of dispersants used.

### SUMMARY

According to embodiments of the present disclosure, a resin particle is provided which contains a binder resin containing a polyester resin containing polyethylene terephthalate and a diol component of propylene glycol and a release agent containing an ester wax.

As another aspect of embodiments of the present disclosure, a toner is provided which contains the resin particle mentioned above.

As another aspect of embodiments of the present disclosure, a developing agent is provided which contains the toner mentioned above and a carrier.

As another aspect of embodiments of the present disclosure, a toner accommodating unit is provided which contains the toner mentioned above.

### BRIEF DESCRIPTION OF THE VIEW OF THE DRAWINGS

A more complete appreciation of the disclosure and many of the attendant advantages and features thereof can be readily obtained and understood from the following detailed description with reference to the accompanying drawing, wherein:

FIGURE is a diagram illustrating a schematic configuration of a process cartridge that accommodates the toner according to an embodiment of the present invention and that is detachably attachable to an image forming apparatus.

The accompanying drawings are intended to depict example embodiments of the present invention and should not be interpreted to limit the scope thereof. The accompanying drawings are not to be considered as drawn to scale unless explicitly noted. Also, identical or similar reference numerals designate identical or similar components throughout the several views.

### DESCRIPTION OF THE EMBODIMENTS

The terminology used herein is for the purpose of describing particular embodiments only and is not intended to be limiting of the present invention. As used herein, the singular forms “a,” “an,” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Embodiments of the present invention are described in detail below with reference to accompanying drawings. In describing embodiments illustrated in the drawings, specific terminology is employed for the sake of clarity. However, the disclosure of this patent specification is not intended to be limited to the specific terminology so selected, and it is to be understood that each specific element includes all technical equivalents that have a similar function, operate in a similar manner, and achieve a similar result.

For the sake of simplicity, the same reference number will be given to identical constituent elements such as parts and materials having the same functions and redundant descriptions thereof omitted unless otherwise stated.

According to the present disclosure, a resin particle is provided that achieves less environmental burden with high durability.

The resin particle of the present invention is described in detail below. The present invention is not limited to the following embodiments and can be changed within the scope of the present invention. In the ranges of from a figure A to figure B in the present specification, the figure A and the figure B are both inclusive as the lower limit and the upper limit.

The present invention is related to resin particles but the toner is described below as a specific example of the resin particle. Thus, the resin particle is referred to as toner.

Using a plant-derived resin in a polymerization toner produced with a small amount of energy has been proposed in Japanese Patent Application Publication No. 2015-025851. However, the plant-based resins adopted decrease the strength of the toner, resulting in an unsatisfactory quality.

The inventors of the present invention have diligently researched resin particles used as toner. As a result, they have discovered that combining propylene glycol, ester wax, and polyethylene terephthalate (hereinafter referred to as “PET”) yields resin particles with low environmental impact and high durability. Specifically, the combination of propylene glycol and ester wax enables the dispersion of release agents within the resin particles without the need for dispersants. Additionally, the use of recycled PET reduces environmental impact.

### Toner

The toner of the present invention contains an ester wax as a release agent, including at least a polyester resin as a binder resin, incorporating PET as a component of the polyester resin, and containing propylene glycol as a diol component constituting the binder resin.

The toner of the present invention preferably employs a core-shell structure. The core-shell structure increases the strength of the toner surface, thereby improving the durability of the toner.

In the entire circumferential length of the outermost surface of the toner of the present invention, the ratio of the circumferential length occupied by the release agent is preferably 5 or less percent and more preferably 3 or less percent. If it exceeds 5 percent, the release agent present on the surface reduces the strength of the toner.

Propylene glycol used as a raw material for the toner of the present invention is of non-petroleum origin. Using non-petroleum-derived propylene glycol as a raw material makes it possible to reduce the environmental burden of the toner.

As a raw material for the toner of the present invention, recycled PET is preferable. Using recycled PET as a raw material makes it possible to reduce the environmental burden of the toner. Additionally, off-spec fiber scraps or pellets may also be employed, other than the recycled product.

The main compositions of the toner of the present invention are described below.

### Ester Wax

The toner of the present invention contains an ester wax. The ester wax used in the present invention has a sharper carbon number distribution compared to natural paraffin wax and microcrystalline wax, which are commonly used as raw materials for present toners. Thus, this ester wax contributes to improvement of toner durability.

Generally, ester wax is synthesized from high-grade alcohol components and high-grade carboxylic acid components. These high-grade alcohol and carboxylic acid components are often obtained from natural sources and typically consist of mixtures with an even number of carbons. If these mixtures are directly esterified, they tend to produce multiple by-products in addition to the desired ester compounds, which can adversely affect various properties of the toner. In such cases, the raw materials and products are purified through solvent extraction or vacuum distillation operations to obtain ester wax with adjusted carbon number distribution.

Ester wax and polyester resin containing propylene glycol have high affinity, resulting in improved dispersion of the ester wax in resin particles.

The melting point of the ester wax is not particularly limited and can be suitably selected to suit to a particular application. The melting point is preferably from 50 to 120 degrees C. and more preferably from 60 to 90 degrees C. A melting point of the ester wax of 50 or higher degrees C. prevents adverse impacts on the high temperature storage stability, while a melting point of 120 or lower degrees C. prevents cold offset during low-temperature fixing. Regarding the melt viscosity measurements of the ester wax, it is preferably from 5 to 1,000 cps, with 10 to 100 cps being even more preferable, at a temperature 20 degrees C. higher than the melting point of the wax. A melt viscosity of 5 or more cps prevents a decrease in releasability, while a melt viscosity of 1,000 or less cps is sufficient to demonstrate resistance to hot offset, as well as low-temperature fixability. The proportion of ester wax to the toner mentioned above is not particularly limited and can be suitably selected to suit to a particular application. For example, it is preferably from 0 to 40 percent by mass and more preferably from 3 to 30 percent by mass. A proportion of 40 or less percent by mass prevents a decrease in flowability of the toner.

### Polyethylene Terephthalate (PET)

In the present invention, PET is contained as a binder resin. Recycled PET in a flake form may also be used, with a weight-average molecular weight (Mw) of around 30,000 to 90,000 for the recycled material. There are no restrictions on molecular weight distributions, compositions, manufacturing methods, or forms used during application. The ratio of recycled PET can be adjusted in synthesizing polyester resins, tuning the environmental friendliness and toner quality.

As the substitute for PET, polybutylene terephthalate (PBT) and its recycled products can be used.

### Other Binder Resin

As the binder resin other than PET, it preferably includes amorphous polyester resin, which is advantageous for achieving excellent low-temperature fixability. Among these, linear polyester resins are preferred. Additionally, unmodified polyester resins are preferable.

The unmodified polyester resin is obtained using a polyol with a polycarboxylic acid including polycarboxylic anhydride, polycarboxylic acid ester, and their derivatives. However, it is not modified with a substance such as an isocyanate compound.

Preferably, the amorphous polyester resin is free of a urethane or urea bonding.

Polyhydric alcohol mentioned above includes at least propylene glycol. Its combinational use with the ester wax mentioned later makes it possible to disperse the release agent in the toner without using dispersants, thus enabling the production of resin particles with low environmental impact. Additionally, using non-petroleum-derived propylene glycol further reduces environmental burden.

The content of propylene glycol in the binder resin is preferably 5 or more percent of the total binder resin.

The polyhydric alcohol may include polyhydric alcohols other than propylene glycol.

There are no particular restrictions on the polyhydric alcohol, and it can be selected as needed depending on the purpose. For example, diols can be listed.

Specific examples of diol other than propylene glycol include, but are not limited to, ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, 1,20-eicosanediol, bisphenol A, an adduct of alkylene (carbon number 2-3) oxides of bisphenol A with an average addition mole number of 1 to 10 of alkylene oxide with 2 to 3 carbon atoms, hydrogenated bisphenol A, and an adduct of hydrogenated bisphenol A with an average addition mole number of 1 to 10 of alkylene oxide with 2 to 3 carbon atoms. These can be used alone or in combination.

A specific example of the polycarboxylic acid is dicarboxylic acid.

Specific examples of dicarboxylic acids include, but are not limited to, saturated aliphatic dicarboxylic acid such as oxalic acid, malonic acid, succinic acid, glutaric acid, adipic acid, suberic acid, azelaic acid, sebacic acid, 1,9-nonane dicarboxylic acid, 1,10-decane dicarboxylic acid, 1,12-dodecane dicarboxylic acid, 1,14-tetradecane dicarboxylic acid, and 1,18-octadecane dicarboxylic acid and aromatic dicarboxylic acids such as phthalic acid, isophthalic acid, terephthalic acid, and naphthalene-2,6-dicarboxylic acid. They include anhydrides or lower alkylesters (1 to 3 carbon atoms) thereof. These can be used alone or in combination. Of these, inclusion of 50 or more mol percent of terephthalic acid is preferable achieve excellent high temperature storage.

The amorphous polyester resin mentioned above may optionally contain at least either a tri- or higher carboxylic acid or a tri- or higher alcohol to adjust the acid value and hydroxyl values.

Specific examples of tri- or higher carboxylic acid include, but are not limited to, trimellitic acid, pyromellitic acid, and their anhydrides.

Specific examples of tri- or higher alcohol include, but are not limited to, glycerin, pentaerythritol, and trimethylol propane.

The molecular weight of the amorphous polyester resin is not particularly limited and can be suitably selected to suit to a particular application. The weight average molecular weight Mw is preferably from 3,000 to 10,000 as measured by gel permeation chromatography (GPC). The number average molecular weight Mn is preferably from 1,000 to 4,000. The ratio of Mw/Mn is preferably from 1.0 to 4.0.

A molecular weight not lower than the lower limit mentioned above prevents the toner's high temperature storage stability and durability under stress such as stirring in a developing device from lowering. A molecular weight up to the upper limit mentioned above prevents the toner's viscoelasticity during the melting process from increasing and its low temperature fixability from lowering.

The weight average molecular weight Mw is more preferably from 4,000 to 7,000. The number average molecular weight Mn is more preferably from 1,500 to 3,000. The ratio of Mw/Mn is more preferably from 1.0 to 3.5.

The acid value of the amorphous polyester resin is not particularly limited and can be suitably selected to suit to a particular application. The acid value is preferably from 1 to 50 mgKOH/g and more preferably from 5 to 30 mgKOH/g. An acid value of 1 or greater mgKOH/g tends to negatively charge a toner and enhances the affinity between paper and the toner during fixing on the paper, enhancing the low temperature fixability. An acid value of 50 or less mgKOH/g prevents the charging stability, particularly charging stability to environmental fluctuation, from deteriorating.

The hydroxyl value of the amorphous polyester resin is not particularly limited and can be suitably selected to suit to a particular application. The value is preferably 5 or more mgKOH/g.

The glass transition temperature Tg of the amorphous polyester resin is preferably from 40 to 80 degrees C. and more preferably from 50 to 70 degrees C. A glass transition temperature of 40 or higher degrees C. enhances the high temperature storage stability and the durability to stress such as stirring in a developing device while enhancing resistance to filming. A glass transition temperature of 80 or lower degrees C. suitably transforms the shape of toner with heat and pressure in fixing, thereby enhancing the low temperature fixability.

The molecular structure of the amorphous polyester resin can be analyzed in solution or solid state using NMR, along with other methods such as X-ray diffraction, GC/MS, LC/MS, and infrared (IR) absorption. Amorphous polyester resin can be simply detected as a substance that does not exhibit absorption at 965±10 cm⁻¹ and 990±10 cm⁻¹, which are based on the δ_{CH} (out-of-plane bending vibration) of olefins in the infrared absorption spectrum.

The content of the amorphous polyester resin is not particularly limited and can be suitably selected to suit to a particular application. The number of parts of the amorphous polyester resin to 100 parts by mass of the toner mentioned above is preferably from 50 to 90 parts by mass and more preferably from 60 to 80 parts by mass. Fifty or more parts by mass reduces a decrease in dispersibility of the pigment and release agent in the toner and minimizes fogging and disturbance of an image. Ninety or less parts by mass reduces a decrease in low temperature fixability. Content in the more preferable region specified above is advantageous for achieving excellent image quality and low temperature fixability.

### Colorant

The suitable colorant (coloring material) for use in the present invention includes known dyes and pigments.

Specific examples include, but are not limited to, carbon black, Nigrosine dyes, black iron oxide, Naphthol Yellow S, Hansa Yellow (10G, 5G and G), Cadmium Yellow, yellow iron oxide, loess, chrome yellow, Titan Yellow, polyazo yellow, Oil Yellow, Hansa Yellow (GR, A, RN and R), Pigment Yellow L, Benzidine Yellow (G and GR), Permanent Yellow (NCG), Vulcan Fast Yellow (5G and R), Tartrazine Lake, Quinoline Yellow Lake, Anthrazane Yellow BGL, isoindolinone yellow, red iron oxide, red lead, orange lead, cadmium red, cadmium mercury red, antimony orange, Permanent Red 4R, Para Red, Faise Red, p-chloro-o-nitroaniline red, Lithol Fast Scarlet G, Brilliant Fast Scarlet, Brilliant Carmine BS, Permanent Red (F2R, F4R, FRL, FRLL and F4RH), Fast Scarlet VD, Vulcan Fast Rubine B, Brilliant Scarlet G, Lithol Rubine GX, Permanent Red F5R, Brilliant Carmine 6B, Pigment Scarlet 3B, Bordeaux 5B, Toluidine Maroon, Permanent Bordeaux F2K, Helio Bordeaux BL, Bordeaux 10B, BON Maroon Light, BON Maroon Medium, Eosin Lake, Rhodamine Lake B, Rhodamine Lake Y, Alizarine Lake, Thioindigo Red B, Thioindigo Maroon, Oil Red, Quinacridone Red, Pyrazolone Red, polyazo red, Chrome Vermilion, Benzidine Orange, perynone orange, Oil Orange, cobalt blue, cerulean blue, Alkali Blue Lake, Peacock Blue Lake, Victoria Blue Lake, metal-free Phthalocyanine Blue, Phthalocyanine Blue, Fast Sky Blue, Indanthrene Blue (RS and BC), Indigo, ultramarine, Prussian blue, Anthraquinone BlueFast Violet B, Methyl Violet Lake, cobalt violet, manganese violet, dioxane violet, Anthraquinone Violet, Chrome Green, zinc green, chromium oxide, viridian, emerald green, Pigment Green B, Naphthol Green B, Green Gold, Acid Green Lake, Malachite Green Lake, Phthalocyanine Green, Anthraquinone Green, titanium oxide, zinc oxide, lithopone and the like. These materials can be used alone or in combination.

The toner according to the present embodiment can be effectively used as a material for developing agents or used in toner accommodating units for image formation.

### Developing Agent

The developing agent of an embodiment of the present invention contains the toner relating to one embodiment of the present invention and other optional components such as a carrier. The developing agent can thus stably form quality images with excellent transfer properties and chargeability.

The developing agent can be a one-component or two-component developing agent. A two-component developing agent is preferable for a high-performance printer that supports high speed information processing of late to enjoy a longer working life.

As for the toner relating to an embodiment of the present invention used as a one-component development, the toner particle size almost never changes upon toner replenishment. Due to this stable toner particle size, the toner is less likely to form a film on the developing roller and fusion-bond on the members such as a blade for regulating the thickness of the toner layer. The toner can thus produce quality images with good and stable developability even after agitating in the developing device for an extended period of time.

In the case that the toner relating to the present embodiment is used as a two-component developing agent, it is mixed with a carrier. As for the toner according to an embodiment of the present invention used as a two-component development, the toner particle size does not vary upon toner replenishments for an extended period of time. Due to this stable toner particle size, the toner can thus produce quality images with good and stable developability even after the toner is agitated in the developing device for an extended period of time.

The content of the carrier in a two-component developing agent can be suitably selected to suit to a particular application. The content is preferably from 90 to 98 parts by mass and more preferably from 93 to 97 parts by mass to 100 parts of a two-component developing agent.

The developing agent of the present embodiment can be suitably used for image formation by various known electrophotography such as a magnetic one-component developing method, a non-magnetic one-component developing method, and a two-component developing method.

### Carrier

The carrier is not particularly limited and can be suitably selected to suit to a particular application. Preferably, a carrier contains a core material and a resin layer (cover layer) covering the core material.

### Core Material

The material of the core material is not particularly limited and can be suitably selected to suit to a particular application.

Specific examples include, but are not limited to, a manganese-strontium-based material of from 50 to 90 emu/g and a manganese-magnesium-based material of from 50 to 90 emu/g. To achieve a suitable image density, using a high magnetized material such as powdered iron not less than 100 emu/g and magnetite from 75 to 120 emu/g is preferable. Low magnetized materials such as copper-zinc based material having 30 to 80 emu/g are preferable because it can reduce an impact of the developing agent in a filament state on a photoconductor and is advantageous to enhance the image quality. These may be used alone or in a combination of two or more thereof.

The volume average particle diameter of the core material is not particularly limited and can be suitably selected to suit a particular application. It is preferably 10 to 150 μm and more preferably from 40 to 100 μm. A volume average particle diameter of or greater 10 μm does not cause a problem of carrier scattering unlike finely-powdered carrier particles that may scatter because of its low magnetization per particle. Conversely, a volume average particle diameter of 150 or less μm prevents a problem of toner scattering resulting from a decreased specific surface area of the carrier. This scattering leads to degrading the representation of a solid portion especially in full color printing with many solid portions.

### Resin Layer

The resin layer may contain resin and other optional other components. The resin used in the resin layer can be a material known in the art that can be adequately charged. It includes, but is not limited to, a silicone resin, acrylic resin, or a combination thereof. Preferably, the composition for forming a resin layer contains a silane coupling agent.

The resin layer preferably has an average thickness of 0.05 to 0.50 μm.

### Toner Accommodating Unit

The toner accommodating unit relating to the present embodiment can accommodate the toner relating to the present embodiment. The toner accommodating unit in the present embodiment contains toner in a unit capable of accommodating the toner. Examples of the toner accommodating unit include, but are not limited to, a toner accommodating container (toner containing unit), a developing unit, and a process cartridge.

The toner accommodating container is a vessel containing a toner.

The developing unit has a device for accommodating toner and developing with the toner.

The process cartridge integrally includes at least a latent electrostatic image bearer (also referred to as an image bearer) and a developing device, accommodates toner, and is detachably attachable to an image forming apparatus. The process cartridge may further include at least one member selected from the group consisting of a charging unit, an exposing unit (quencher, discharger), and a cleaning unit.

### Aspect of Process Cartridge

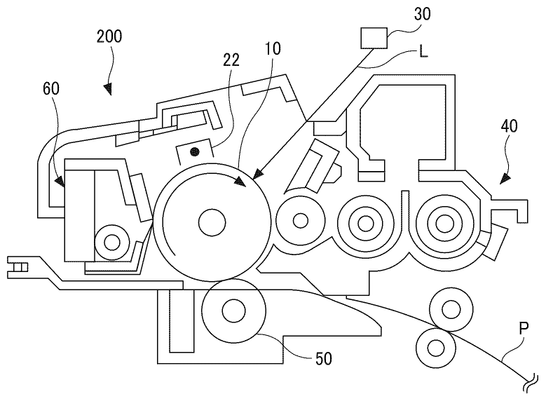

An aspect of the process cartridge relating to the present embodiment is described with reference to the drawing. FIG. 1s a diagram illustrating an example of the process cartridge of the present embodiment. As illustrated in the drawing, a process cartridge 200 includes a drum photoconductor 10, a corona charger 22 as a charging unit, a developing device 40, a transfer roller 50, and a cleaning device 60. In the drawing, P represents a printing medium and L represents an irradiation light.

### Measuring Method

### Diameter of Toner Particle

The diameter of toner particle is measured with Coulter Multisizer III (available from Beckman Coulter, Inc.). The diameter of toner particle is measured in the following manner.

A total of 2 mL of a surfactant, dodecyl benzene sulphonic acid sodium, available from Tokyo Chemical Industry Co. Ltd., is added as a dispersant to 100 mL of an electrolyte. The electrolyte used is NaCl aqueous solution at approximately 1 percent prepared by using primary sodium chloride. The electrolyte was ISOTON-II (available from Beckman Coulter, Inc.). A total of 10 mg of a solid measuring sample is added to the liquid mixture containing the electrolyte and the surfactant to obtain an electrolyte in which the sample is suspended. The electrolyte in which the sample is suspended was subjected to dispersing with an ultrasonic wave dispersing device for about one to about three minutes. The toner's volume and number are measured with Coulter Multisizer III with an aperture of 100 μm to calculate the volume distribution and the number distribution. The volume average particle diameter Dv of the toner is calculated from the distributions obtained.

### Average Particle Diameter and Average Circularity

In this embodiment, the average particle diameter and average circularity are measured by using a flow-type particle image analyzer, FPIA-3000, available from Sysmex Corporation.

The specific procedure for obtaining the average circularity is as follows: (1) A surfactant as a dispersion agent, preferably 0.1 to 0.5 ml of an alkylbenzenesulfonic acid salt, is added to 100 to 150 ml of water from which solid impurities have been preliminarily removed; (2) about 0.1 to about 0.5 g of a sample to be measured is added to the mixture prepared in (1); (3) the liquid suspension in which the sample is dispersed is dispersed with an ultrasonic dispersion device for about 1 to about 3 minutes to achieve a concentration of the particles of from 3,000 to 10,000 particles per microliter; and (4) the average particle diameter, the average circularity, and the standard deviation (SD) of the circularity are measured with the device mentioned above.

The particle diameter is defined as the equivalent circle diameter. The average particle diameter is obtained from the equivalent circle diameter based on number. The analysis conditions of the flow bed particle image analyzer are as follows.
Limitation to particle diameter: 0.5 μm≤equivalent circle diameter based on number≤200.0 μm
Limitation to particle shape: 0.93≤circularity≤1.00

The definition of the average circularity in the present embodiment is as follows.

Average circularity=(perimeter of circle having same area as that of projected image of particle)/(perimeter of projected image of particle)

### Measuring of Molecular Weight

One way of measuring the molecular weight of each component of a toner is as follows.
Gel permeation chromatography (GPC) measuring device: GPC-8220 GPC, available from TOSOH CORPORATION
Column: TSK gel Super HZM-H, 15 cm triplet, available from TOSOH CORPORATION
Temperature: 40 degrees C.
Solvent: THF
Flow rate: 0.35 mL/min
Sample: 100 μl of 0.15 percent by mass
Pretreatment of sample: toner is dissolved in tetrahydrofuran (THF) containing a stabilizer, available from Wako Pure Chemical Industries, Ltd., at 0.15 percent by mass, followed by filtering with a 0.2 μm filter. The filtrate is used as a sample. A total of 100 μL of the THF sample solution is placed in the measuring device.

For the molecular weight measuring, the molecular weight distribution of a sample is calculated according to the relationship between the number of counts and the logarithm values of the calibration curve created from several types of the monodispersed polystyrene reference samples. As the reference polystyrene sample for the calibration curve, Showdex STANDARD Std. No. S-7300, S-210, S-390, S-875, S-1980, S-10.9, S-629, S-3.0, and S-0.580, all available from Showa Denko K.K., are used. A refractive index (RI) detector is used as a detector.

### Thickness of Shell

The shell's thickness is measured based on the cross section image of an ultra thin piece of toner using a transmission electron microscope (TEM).

The shell's thickness is the value obtained by the calculation according to the following relationship. It is preferable to obtain the shell's thickness using an image processing software; however, the devices are not limited to the TEM, image analyzer, or software mentioned above as long as the same analysis results are obtained.

Shell's thickness=average equivalent circle diameter of core-shell resin particle/average equivalent circle diameter of core

The average equivalent circle diameter can be calculated by binarization with an imaging software.

### Observation and Measuring by Transmission Electron Microscope (TEM)

Manufactured toner is embedded and cured. An ultra thin piece with a thickness of about 100 nm of the toner is prepared with an ultramicrotome (ULTRACUT UCT, using a diamond knife, available from Leica Corporation).

The sample is exposed to gas of ruthenium tetroxide, osmium tetroxide, or another dyeing agent to distinguish the core from the shell layer. The time spent in the exposure is appropriately adjusted depending on the contrast during observation. Thereafter, the sample is observed with TEM, JEM-2100, available from JEOL Ltd. at an accelerating voltage of 100 kV. Imparting a compositional contrast by another method such as selective etching is also possible. Observing and evaluating the core and shell layer using a TEM after such a pre-treatment is also preferable.

The average equivalent circle diameter of the core-shell resin particle and the average equivalent circle diameter of the core of the cross section image are calculated by binarization using a procurable imaging software such as Image-Pro Plus. The average equivalent circle diameter is obtained from 20 toner cross sections.

In the present invention, the toner is embedded in epoxy resin and ultrathin-sectioned to approximately 100 μm, followed by staining with ruthenium tetroxide. A cross section of the toner is observed and photographed at a magnification factor of 10,000× using a transmission electron microscope (JEM-2100, available from JEOL Ltd.). The 20 photographs of 20 toner particles taken are subjected to image evaluation to measure the perimeter (circumference length) of the outermost surface of the resin particles and the length occupied by the release agent along the circumference are measured.

### Analysis of Resin Composition of Surface Layer

Whether the surface layer contains a PET-derived resin component can be confirmed by the composition analysis of the surface layer using nanoIR. The composition is analyzed by obtaining the IR spectrum of a fine particle surface layer according to the analysis for realizing the nanoscale resolution by the combination of nano IR's AFM with IR. Whether the PET derived composition is present in the surface layer can be determined by this analysis.

### Analysis of Toner Constituting Component

The glass transition temperature (Tg), melting point, acid value, hydroxyl value, and molecular weight of the amorphous polyester resin, PET or PBT, and release agent in the resin particle, as well as the mass ratio of each component in the resin particle, may be measured individually. Alternatively, the resin particles of the present invention can be separated by GPC or similar methods into the respective components, which are then analyzed for calculation using the method described later.

One way of separating each component in the resin particle by GPC is as follows.

In GPC measurements using chloroform as the mobile phase, the eluate obtained undergoes preparatory steps, such as fraction collection, followed by the aggregation of fractions corresponding to the desired molecular weight range from the entire elution curve area.

The resulting eluate is subsequently condensed and dried with equipment such as an evaporator. Next, the solid residue is dissolved in a deuterated solvent such as deuterated chloroform or deuterated THF followed by 1H-NMR measuring. Finally, the ratios of compositional components of the resin in the eluted components are calculated based on the integration ratio of each element.

Alternatively, the combined eluate is concentrated, followed by hydrolysis using such a substance as sodium hydroxide. The decomposition products obtained are qualitatively and quantitatively analyzed by, for example, high-performance liquid chromatography (HPLC), to calculate the ratio of each component in the resin particle.

Furthermore, in cases where the method of manufacturing the resin particles involves forming the base particles of the resin particles while generating amorphous polyester resin through extension reaction and/or crosslinking reaction of nonlinear reactive precursors and curing agents, the resin particle of the present invention is separated by GPC or the like, and parameters such as the glass transition temperature (Tg) of the amorphous polyester resin can be determined. Additionally, an amorphous polyester resin is separately synthesized through extension reaction and/or crosslinking reaction of nonlinear reactive precursors and curing agents to determine parameters such as the glass transition temperature (Tg) from the synthesized amorphous polyester.

One way of manufacturing the toner of the present invention is described below. The method of manufacturing the toner according to the present invention is not limited to the methods described below. Known manufacturing methods can be employed as long as they fulfill the requirements set forth by the present invention.

### Preparation of Liquid Dispersion of Resin

A liquid dispersion of resin in which a binder resin, a colorant, a cross-linking material, and ester wax are dissolved or dispersed is prepared. The method of preparing the liquid dispersion of resin is not particularly limited and can be selected to suit to a particular application. One way of preparation is to gradually add raw materials such as resin to deionized water during stirring to dissolve or disperse them. For dispersion, known devices such as a bead mill or disk mill can be used.

### Emulsification Process

Next, the liquid dispersion of resin obtained is subjected to particle size reduction.

In the present invention, the liquid dispersion of resin obtained in the previous stage is neutralized with an alkali such as sodium hydroxide or ammonia water. Subsequently, an aqueous phase containing water, organic solvent, and surfactant is added to obtain an emulsion slurry.

### Organic Solvent

As the organic solvent, a volatile organic solvent with a boiling point lower than 100 degrees C. is preferable to readily remove the organic solvent later.

Specific examples of the organic solvent include, but are not limited to, toluene, xylene, benzene, carbon tetrachloride, methylene chloride, 1,2-dichloroethane, 1,1,2-trichloroethane, trichloroethylene, chloroform, monochlorobenzene, dichloroethylidene, methyl acetate, ethyl acetate, methylethyl ketone, methylisobutyl ketone, methanol, ethanol, and isopropyl alcohol. These can be used alone or in combination. A resin having a polyester backbone is well dissolved or dispersed in an organic solvent such as ester-based solvents including methyl acetate, ethyl acetate, and butyl acetate or ketone-based solvents including methylethyl ketone and methyl isobutyl ketone. Of these, methyl acetate, ethyl acetate, and methyl ethyl ketone are particularly preferable to readily purge the liquid dispersion of the organic solvent later.

### Removal of Solvent

One way of removing the organic solvent from the thus-prepared emulsified slurry is to gradually raise the temperature of the entire system during stirring to completely evaporate and remove the organic solvent in liquid droplets. Another approach involves spraying the obtained emulsified slurry in a dried atmosphere during stirring for the complete removal of the organic solvent in droplets. Alternatively, the organic solvent can be evaporated and removed under reduced pressure under stirring of the emulsified slurry. The latter two methods can be employed in conjunction with the first one.

Various gases such as air, nitrogen, carbon dioxide, heated gases including combustion gases, and gases heated to temperatures at or exceeding the boiling point of the highest boiling point solvent employed are commonly used as the drying atmosphere for spraying the emulsified slurry. Short-term processing using equipment such as a spray dryer, belt dryer, and rotary kiln, is sufficient to achieve the desired quality.

The above methods make it possible to obtain a liquid dispersion of colored fine particles from which the organic solvent has been removed.

### Process of Aggregation

Next, the liquid dispersion of colored fine particles obtained is agitated to obtain aggregated particles with a target particle size. For aggregation, a known method is employed such as adding a flocculant and adjusting pH. While the flocculant can be added directly, it is preferable to use an aqueous solution containing the flocculant to avoid local high concentrations. In addition, it is preferable to slowly add an aggregated salt while the particle diameter of a colored particle is monitored.

It is preferable for the temperature of the liquid dispersion during aggregation to be close to the glass transition temperature (Tg) of the resin being used. If the temperature is too low, it can impede efficient aggregation progress, while excessively high temperatures can accelerate aggregation, resulting in the formation of coarse particles and deterioration of particle size distribution

Once the target particle size is achieved, the aggregation process is halted. Aggregation can be stopped by adding a low ion-valence salt or chelate agent, adjusting pH, lowering the temperature of a liquid dispersion, or decreasing the concentration with much amount of an aqueous medium.

The liquid dispersion containing colored aggregated particles is obtained by the methods described above.

Any known flocculant (aggregating agent) can be used. Examples include, but are not limited to, metal salts of monovalent metals such as sodium and potassium, metal salts of divalent metals such as calcium and magnesium, and metal salts of trivalent metals such as iron and aluminum.

### Processes of Fusion

The aggregated particles obtained are fused by heating to reduce the roughness of the particles, thus obtaining spheroidized particles. To fuse the aggregated particles, the liquid dispersion of the colored aggregated particle is heated during stirring. The temperature of the liquid is preferably around a little above the glass transition temperature Tg of the resin being used.

### Processes of Shell Forming

The toner of the present invention preferably employs shell forming.

There is no specific limitation to the method of forming a shell layer and any method known in the art can be suitably selected to suit to a particular application. One way of forming a shell layer is to prepare a spheroisized particle with a target particle size in fusing, add an amorphous resin to the particle, and repeat aggregation and fusing.

The liquid dispersion of toner particles is obtained by the methods described above.

### Process of Rinsing and Drying

The liquid dispersion of toner particle obtained by the method described above contains auxiliary materials such as aggregated salts other than the toner particles. The liquid dispersion should thus be rinsed to extract the toner particles alone.

A method such as centrifugation, filtering under reduced pressure, or filter pressing can be employed to rinse the toner particle. The method is not particularly limited in the present invention. Cakes of toner particles can be obtained by any of the methods. In the case that the toner particles are not rinsed sufficiently by one cycle of rinsing, the cake obtained is again dispersed in an aqueous solvent to obtain a slurry followed by repeating extracting the toner particles by any of the methods mentioned above. Alternatively, if filtering under a reduced pressure or filter-pressing is employed, it is possible to rinse off the auxiliary materials in the toner particles by passing an aqueous solvent through the cake.

The aqueous medium used for rinsing is either water or a solvent mixture of water with alcohols such as methanol or ethanol. To reduce the cost and the environmental burden, water is preferable.

Since the rinsed toner particles retain a considerable amount of aqueous medium inside, the aqueous medium is removed by drying to obtain toner particles alone.

In the drying method, it is possible to use a drier such as a spray drier, vacuum freeze drier, vacuum drier, ventilation rack drier, mobile rack drier, fluid bed drier, rotary drier, and stirring drier.

Preferably, the dried toner particle is further dried until the moisture in the particle is less than 1 percent.

The dried resin particles are in a state of being softly aggregated. If these softly-aggregated particles are not convenient for use, it is suitable to deaggregate them with a device such as a jet mill, Henschel mixer, super mixer, coffee mill, Oster blender, and food processor to loosen them.

### External Additive Treatment

Additives such as inorganic fine particles, fine polymer particles, and a cleaning improver can be added to the toner particle obtained in an embodiment of the present invention to enhance the flowability, chargeability, and cleaning properties of the toner particle.

Specific examples of such mixing methods include, but are not limited to, a method in which an impact is applied to a mixture with a blade rotating at a high speed and a method in which a mixture is put into a jet air to collide particles against each other or complex particles to a suitable collision plate.

Specific examples of such mechanical impact applicators include, but are not limited to, ONG MILL (available from Hosokawa Micron Co., Ltd.), modified I TYPE MILL in which the pressure of air used for pulverizing is reduced (available from Nippon Pneumatic Mfg. Co., Ltd.), HYBRIDIZATION SYSTEM (available from Nara Machine Co., Ltd.), KRYPTRON SYSTEM (available from Kawasaki Heavy Industries, Ltd.), and automatic mortars.

### External Additive

The inorganic fine particle preferably has a primary particle diameter of from 5 nm to 2 μm, and more preferably from 5 nm to 500 nm. In addition, the specific surface area of such inorganic particulates measured by the BET method is preferably from 20 to 500 m²/g. The proportion of this inorganic fine particle to a toner is preferably from 0.01 to 5 percent by mass.

Specific examples of such inorganic fine particles include, but are not limited to, silica, alumina, titanium oxide, barium titanate, magnesium titanate, calcium titanate, strontium titanate, zinc oxide, tin oxide, quartz sand, clay, mica, sand-lime, diatom earth, chromium oxide, cerium oxide, red iron oxide, antimony trioxide, magnesium oxide, zirconium oxide, barium sulfate, barium carbonate, calcium carbonate, silicon carbide, and silicon nitride.

The fine polymer particles include, but are not limited to, polystyrene, methacrylates, and acrylates obtained by soap-free emulsion polymerization, suspension polymerization, or dispersion polymerization, and polycondensed particles such as silicone, benzoguanamine, and nylon, and polymer particles of thermocuring resin.

The external additive such as a fluidizer can be hydrophobized by surface treatment to enhance the hydrophobicity and prevent the deterioration of the fluidity and chargeability in a high humidity environment.

Preferred specific examples of surface treatment agents include, but are not limited to, silane coupling agents, silyl agents, silane coupling agents having a fluorine alkyl group, organic titanate coupling agents, aluminum-based coupling agents, silicone oil, and modified-silicone oil.

Cleaning improvers are used to remove the developing agent remaining on an image bearer such as a photoconductor and a primary transfer body.

Specific examples include, but are not limited to, zinc stearate, calcium stearate and metal salts of fatty acid acids such as stearic acid and polymeric fine particles such as polymethyl methacrylate fine particles and polystyrene fine particles, which are prepared by a method such as soap-free emulsion polymerization. Such polymeric fine particles preferably have a relatively sharp particle size distribution and a volume average particle size of from 0.01 to 1 μm.

The terms of image forming, recording, and printing in the present disclosure represent the same meaning.

Also, recording media, media, and print substrates in the present disclosure have the same meaning unless otherwise specified.

Having generally described preferred embodiments of this disclosure, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

Hereinafter, the present invention is described in more detail based on Examples and Comparative Examples, but the technical scope of the present invention is not limited to thereto.

### Synthesis of Amorphous Polyester Resin B-1

A four-necked flask equipped with a nitrogen introduction tube, a dehydration tube, a stirrer, and a thermocouple was charged with propylene glycol (biomass-derived alcohol), an adduct of bisphenol A with 2 mols of propylene oxide (petroleum-derived alcohol), terephthalic acid, and adipic acid. The molar ratio of propylene glycol to the adduct of bisphenol A with propylene oxide was 20/80, while the molar ratio of terephthalic acid to adipic acid was 97/3. The molar ratio of hydroxyl groups to carboxyl groups (OH/COOH) was adjusted to 1.3. Flake-like polyethylene terephthalate (PET) was added to the resin component to make up 50 percent by mass, along with titanium tetraisopropoxide (500 ppm relative to the resin component). The mixture was allowed to react at atmospheric pressure and 230 degrees C. for 8 hours, followed by further reaction under reduced pressure of 10 to 15 mmHg for 4 hours. Anhydrous trimellitic acid was then added to the reaction vessel to make up 1 mol percent relative to the total resin component, and the reaction was continued at 180 degrees C. and atmospheric pressure for 3 hours to obtain Amorphous Polyester Resin B-1.

### Synthesis of Amorphous Polyester Resins B-2 to B-5

Amorphous Resins B-2 to B-5 were synthesized in the same manner as in Synthesis of Amorphous Polyester Resin B-1 except that the molar ratio of propylene glycol to the adduct of bisphenol A with propylene oxide and the amount of PET added were changed to those shown in Table 1.

TABLE 1

| | | Amorphous polyester resin | | | | |
|---|---|---|---|---|---|---|
| | | B-1 | B-2 | B-3 | B-4 | B-5 |
| Alcohol | Propylene glycol | 20 | 20 | 20 | 10 | 0 |
| Molar ratio | Adduct of bisphenol A | 80 | 80 | 80 | 90 | 100 |
| | with 2 mols of | | | | | |
| | propylene oxide | | | | | |

| | | | | | |
|---|---|---|---|---|---|
| Amount of polyethylene terephthalte | 50 | 25 | 0 | 0 | 0 |
| added (percent by mass) | | | | | |

### Preparation of Liquid Dispersion W-1 of Release Agent

A total of 180 parts of ester wax (WE-11, synthetic wax of plant-derived monomer, available from NOF CORPORATION) and 17 parts of anionic surfactant (NEOGEN SC, sodium dodecylbenzenesulfonate, available from DKS Co., Ltd.) were added to 720 parts of deionized water. The resulting mixture was dispersed with a homogenizer while being heated to 90 degrees C., thus obtaining Liquid Dispersion W-1 of Release Agent. The concentration of the solid portion of the wax particle obtained was 25 percent.

### Preparation of Liquid Dispersion W-2 of Release Agent

A total of 180 parts of ester wax (HNP-9, available from NOF CORPORATION) and 17 parts of anionic surfactant (NEOGEN SC, sodium dodecylbenzenesulfonate, available from DKS Co., Ltd.) were added to 720 parts of deionized water. The resulting mixture was dispersed with a homogenizer while being heated to 90 degrees C., thus obtaining Liquid Dispersion W-2 of Release Agent. The concentration of the solid portion of the wax particle obtained was 25 percent.

### Preparation of Master Batch (MB)

A total of 1,200 parts of water, 500 parts of carbon black (Printex 35, DBP oil absorption amount of 42 ml/100 mg, PH of 9.5, available from Degussa AG), and 500 parts of Amorphous Polyester Resin B-1 were admixed in a Henschel Mixer (available from NIPPON COKE & ENGINEERING. CO., LTD.). The mixture was kneaded at 150 degrees C. for 30 minutes using two rolls and rolled and cooled down followed by pulverization with a pulverizer to obtain Master Batch 1.

### Example 1

### Preparation of Liquid Dispersion of Resin

A total of 200 parts (50 parts in solid) of Liquid Dispersion W-1 of Release Agent, 750 parts of Amorphous Polyester Resin B-1, and 100 parts of Master Batch MB-1 were placed in a container and mixed with a TK homomixer (available from PRIMIX Corporation) at 5,000 rpm for 60 minutes to obtain Liquid Dispersion 1 of Resin.

### Preparation of Aqueous Phase

A total of 990 parts of water, 20 parts of sodium dodecyl sulfate, and 90 parts of ethyl acetate were mixed and stirred to obtain a milky white liquid. This liquid was determined as Aqueous Phase 1.

### Emulsification

A total of 20 parts of 28 percent ammonium water was added to 700 parts of Liquid Dispersion 1 of Resin while being stirred with a TK homomixer at a rate of rotation of 8,000 rpm. After ten minutes mixing, 1,200 parts of Aqueous Phase 1 was slowly added dropwise to the liquid mixture to obtain Emulsified Slurry 1.

### Removal of Solvent

Emulsified Slurry 1 was placed in a container equipped with a stirrer and a thermometer followed by purging Emulsified Slurry 1 of the solvent at 30 degrees C. for 180 minutes to obtain Solvent-purged Slurry 1.

### Preparation of Liquid Dispersion of Shell

Liquid Dispersion B-0 of Shell was obtained in the same manner as in Example 1 except that, in the preparation of Liquid Dispersion 1 of resin, Liquid Dispersion W-1 of Release Agent, Amorphous Polyester Resin B-1, and Masterbatch MB-1 were replaced with Amorphous Polyester Resin B-5, 720 parts of deionized water, and 17 parts of an anionic surfactant (Neogen SC, sodium dodecylbenzenesulfonate, available from DKS Co., Ltd.).

### Aggregation

A total of 100 parts of 3 percent solution of magnesium chloride was added dropwise to Solvent-purged Slurry 1, followed by stirring for five minutes. The mixture was then heated to 60 degrees C. A total of 100 parts of Liquid Dispersion B-0 of Shell was added when the particle diameter grew to 5.0 μm, followed by adding dropwise 100 parts of 3 percent solution of magnesium chloride. After five minutes stirring, the temperature was raised to 65 degrees C. and 50 parts of sodium chloride was added to complete the aggregation to obtain Aggregated Slurry 1.

### Fusion

Aggregated Slurry 1 was stirred and heated to 70 degrees C. Aggregated Slurry 1 was then cooled down when the average circularity reached a target of 0.957, thus obtaining Slurry Dispersion 1.

### Rinsing and Drying

A total of 100 parts of Slurry Dispersion 1 was filtered under a reduced pressure to obtain a filtered cake.

Then (1): 100 parts of deionized water was added to the filtered cake and mixed with a TK HOMOMIXER at 12,000 rpm for 10 minutes, followed by filtering.

(2): A total of 100 parts of sodium hydroxide at 10 percent was admixed with the filtered cake obtained in the (1), using a TK Homomixer at 12,000 rpm for 30 minutes, and then filtered under reduced pressure.
(3): A total of 100 parts of hydrochloric acid at 10 percent was admixed with the filtered cake obtained in the (2), using a TK Homomixer at 12,000 rpm for 10 minutes, and subsequently filtered.
(4): 300 parts of deionized water was added to the filtered cake obtained in the (3) and the resulting cake was mixed with a TK HOMOMIXER (at 12,000 rpm for 10 minutes), followed by filtering.

The operations (1) to (4) were repeated twice to obtain Filtered Cake 1.

Filtered Cake 1 was dried with a circulation dryer at 45 degrees C. for 48 hours. The dried cake obtained was sieved with a screen having an opening of 75 μm to obtain Base Resin Particle 1.

Treatment with External Additive

A total of 2.0 parts of an external additive, hydrophobic silica (HDK-2000, available from Clariant AG), was admixed with 100 parts of Base Resin Particle 1 in a Henschel Mixer, followed by filtering with a screen having a 500 mesh opening to obtain Toner 1.

Toners 2 to 7 were prepared in the same manner as Toner 1 except that the type and number of parts of the release agent, binder resin, and Liquid Dispersion of Shell were changed as shown in Table 2.

TABLE 2

| | | | Example | Example | Example | Example |
|---|---|---|---|---|---|---|
| | | | 1 | 2 | 3 | 4 |
| Toner | | | 1 | 2 | 3 | 4 |
| Amount | Amorphous | Type | B-1 | B-2 | B-3 | B-3 |
| added | polyester resin | Amount added | 750 | 750 | 750 | 750 |
| | | (parts by mass) | | | | |
| | Release agent | Type | W-1 | W-1 | W-1 | W-1 |
| | (solid portion) | Amount added | 50 | 50 | 50 | 50 |
| | | (parts by mass) | | | | |
| | Shell B-0 | Amount added | 100 | 100 | 100 | 0 |
| | | (parts by mass) | | | | |
| | MB | Amount added | 100 | 100 | 100 | 100 |
| | | (parts by mass) | | | | |

| | | | | | |
|---|---|---|---|---|---|
| Analysis | Amount (percent by mass) of | 6 | 8 | 10 | 10 |
| value | propylene glycol contained in resin | | | | |
| | Amount (percent by mass)□ | 41 | 19 | 0 | 0 |
| | of components derived from | | | | |
| | polyethylene terephthalate | | | | |
| | contained in resin | | | | |
| | Ratio of a circumferential length | 2 | 2 | 3 | 5 |
| | occupied by release agent | | | | |
| | in entire circumferential length of | | | | |
| | outermost surface of resin particle | | | | |
| | Percent | | | | |
| Evaluation | Environmental friendliness | S | A | B | B |
| | Durability | S | S | A | B |

| | | | Comparative | Comparative | Comparative |
|---|---|---|---|---|---|
| | | | Example 1 | Example 2 | Example 3 |
| Toner | | | 5 | 6 | 7 |
| Amount | Amorphous | Type | B-4 | B-5 | B-3 |
| added | polyester resin | Amount added | 750 | 750 | 750 |
| | | (parts by mass) | | | |
| | Release agent | Type | W-1 | W-1 | W-2 |
| | (solid portion) | Amount added | 50 | 50 | 50 |
| | | (parts by mass) | | | |
| | Shell B-0 | Amount added | 0 | 100 | 0 |
| | | (parts by mass) | | | |
| | MB | Amount added | 100 | 100 | 100 |
| | | (parts by mass) | | | |

| | | | | |
|---|---|---|---|---|
| Analysis | Amount (percent by mass) of | 6 | 0 | 10 |
| value | propylene glycol contained in resin | | | |
| | Amount (percent by mass)□ | 0 | 0 | 0 |
| | of components derived from | | | |
| | polyethylene terephthalate | | | |
| | contained in resin | | | |
| | Ratio of a circumferential length | 6 | 5 | 15 |
| | occupied by release agent | | | |
| | in entire circumferential length of | | | |
| | outermost surface of resin particle | | | |
| | Percent | | | |
| Evaluation | Environmental friendliness | C | C | B |
| | Durability | C | B | C |

These toners were evaluated on environmental friendliness and durability.

### Evaluation Method

### Environmental Friendliness

The environmental friendliness (environmental burden) was determined based on the ratio of the environmentally friendly resin in the toner. The ratio is a calculation figure based on the amount of added each material used.

### Evaluation Criteria

S: Ratio of non-petroleum monomers and recycled PET to entire of binder resin is 40 or more percent by mass
A: Ratio of non-petroleum monomers and recycled PET to entire of binder resin is 20 to less than 40 percent by mass
B: Ratio of non-petroleum monomers and recycled PET to entire of binder resin is 10 to less than 20 percent by mass
C: Ratio of non-petroleum monomers and recycled PET to entire of binder resin is less than 10 percent by mass

### Durability

Toner was removed from the developing agent after printing with a photocopier with a run length of 100,000 sheets. The weight of the carrier remaining is defined as W1. This carrier was placed in toluene to dissolve the molten material. The weight after rinsing and drying is defined as W2. The spent ratio is obtained according to the following relationship and evaluated.

Spent ratio [percent by weight]={(W1−W2)/W1}×100

### Evaluation Criteria

S: Less than 0.01 percent by weight
A: 0.01 to less than 0.02 percent by weight
B: 0.02 to less than 0.05 percent by weight
C: 0.05 or more percent by weight

The results shown in Table 2 suggest that toner containing propylene glycol, ester wax, and PET achieve excellent environmental friendliness and durability. To the contrary, the toner obtained in each Comparative Example are confirmed to be inadequate in at least one of environmental friendliness and durability.

Aspects of the embodiments of the present invention are, for example, as follows:

Aspect 1: A resin particle contains a binder resin and a release agent containing an ester wax, the binder resin containing a polyester resin containing polyethylene terephthalate and a diol component of propylene glycol.

Aspect 2: The resin particle according to Aspect 1 mentioned above, wherein the resin particle includes a core shell structure.

Aspect 3: The resin particle according to Aspect 1 or 2 mentioned above, wherein the circumferential length occupied by the release agent accounts for 5 or less percent of the entire circumferential length of the outermost surface of the resin particle.

Aspect 4: The resin particle according to any one of Aspects 1 to 3 mentioned above, wherein propylene glycol in the binder resin accounts for 5 or more percent by mass of the entire mass of the binder resin.

Aspect 5: The resin particle according to any one of Aspects 1 to 4 mentioned above, wherein propylene glycol in the binder resin is of non-petroleum origin.

Aspect 6: The resin particle according to any one of Aspects 1 to 5 mentioned above, wherein polyethylene terephthalate in the polyester resin contains recycled polyethylene terephthalate.

Aspect 7: The resin particle according to any one of Aspects 1 to 6 mentioned above, wherein the proportion of polyethylene terephthalate in the binder resin is 40 or more percent by mass.

Aspect 8: A toner contains the resin particle of any one of Aspects 1 to 7 mentioned above.

Aspect 9: A developing agent contains the toner of Aspect 8 mentioned above and a carrier.

Aspect 10. A toner accommodating unit contains
the toner of Aspect 8 mentioned above.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A resin particle comprising:
a binder resin comprising:
a polyester resin comprising:
polyethylene terephthalate; and
a diol component of propylene glycol; and
a release agent comprising an ester wax.

2. The resin particle according to claim 1,
wherein the resin particle includes a core shell structure.

3. The resin particle according to claim 1,
wherein a circumferential length occupied by the release agent accounts for 5 or less percent of an entire circumferential length of an outermost surface of the resin particle.

4. The resin particle according to claim 1,
wherein propylene glycol in the binder resin accounts for 5 or more percent by mass of an entire mass of the binder resin.

5. The resin particle according to claim 1,
wherein propylene glycol in the binder resin is of non-petroleum origin.

6. The resin particle according to claim 1,
wherein polyethylene terephthalate in the polyester resin comprises recycled polyethylene terephthalate.

7. The resin particle according to claim 1,
wherein a proportion of polyethylene terephthalate in the binder resin is 40 or more percent by mass.

8. A toner comprising:
the resin particle of claim 1.

9. A developing agent comprising:
the toner of claim 8; and
a carrier.

10. A toner accommodating unit comprising:
the toner of claim 8.
